(19) United States
(12) Patent Application Publication
(10) Pub. No.: US 2025/0209868 A1
(43) Pub. Date: Jun. 26, 2025

(54) DATA PROCESSING SYSTEM, DATA PROCESSING APPARATUS, AND DATA PROCESSING METHOD

(71) Applicant: SUBARU CORPORATION, Tokyo (JP)

(72) Inventors: Shinichi KANDA, Tokyo (JP); Toru YAMAGUCHI, Tokyo (JP); Shintaro KAJINO, Tokyo (JP)

(73) Assignee: SUBARU CORPORATION, Tokyo (JP)

(21) Appl. No.: 19/077,630

(22) Filed: Mar. 12, 2025

Related U.S. Application Data
(63) Continuation of application No. PCT/JP2023/041057, filed on Nov. 15, 2023.

(51) Int. Cl. G07C 5/08; G07C 5/00

(52) U.S. Cl. CPC G07C 5/0808; G07C 5/006

(57) ABSTRACT

A data processing system includes reference vehicles, a target vehicle, and a data processing apparatus. The data processing apparatus is configured to predict a deterioration tendency over time of a component included in the target vehicle. The data processing apparatus includes a first acquirer, a second acquirer, a predictor, and an estimator. The predictor is configured to the predict the deterioration tendency of the component included in the target vehicle by comparing reference deterioration data acquired by the first acquirer and target deterioration data acquired by the second acquirer with each other. The estimator is configured to estimate, with respect to the component included in the target vehicle, one or more deterioration factors and a contribution rate for each of the one or more deterioration factors.

### CROSS-REFERENCE TO RELATED APPLICATIONS

This application is continuation of International Application No. PCT/JP2023/041057, filed on Nov. 15, 2023, the entire content of which are hereby incorporated by reference.

### BACKGROUND

The disclosure relates to a data processing apparatus and a data processing method that perform a predetermined prediction on a component included in a target vehicle, and to a data processing system including the data processing apparatus.

Various methods have been proposed for a system that provides maintenance data on a component included in a vehicle. For example, reference is made to International Publication No. WO2015/132947.

### SUMMARY

An aspect of the disclosure provides a data processing system including reference vehicles, a target vehicle, and a data processing apparatus. The reference vehicles belong to a predetermined vehicle group. The target vehicle is different from the reference vehicles. The data processing apparatus is configured to predict a deterioration tendency over time of a component included in the target vehicle. The data processing apparatus includes a first acquirer, a second acquirer, a predictor, and an estimator. The first acquirer is configured to collect, for each of the components included in the respective reference vehicles, component deterioration data indicating a correspondence relationship between a degree of deterioration of the component and a temporal element of the component, and acquire, as reference deterioration data, a collection of the component deterioration data on the reference vehicles. The component included in the target vehicle and the components included in the respective reference vehicles are the same in kind as each other. The second acquirer is configured to acquire the component deterioration data on the target vehicle as target deterioration data. The predictor is configured to perform a prediction of the deterioration tendency of the component included in the target vehicle by comparing the reference deterioration data acquired by the first acquirer and the target deterioration data acquired by the second acquirer with each other. The estimator is configured to estimate, with respect to the component included in the target vehicle, one or more deterioration factors and a contribution rate for each of the one or more deterioration factors.

An aspect of the disclosure provides a data processing apparatus configured to predict a deterioration tendency over time of a component included in a target vehicle. The target vehicle is different from multiple reference vehicles that belong to a predetermined vehicle group. The data processing apparatus includes a first acquirer, a second acquirer, a predictor, and an estimator. The first acquirer is configured to collect, for each of the components included in the respective reference vehicles, component deterioration data indicating a correspondence relationship between a degree of deterioration of the component and a temporal element of the component, and acquire, as reference deterioration data, a collection of the component deterioration data on the reference vehicles. The component included in the target vehicle and the components included in the respective reference vehicles are the same in kind as each other. The second acquirer is configured to acquire the component deterioration data on the target vehicle as target deterioration data. The predictor is configured to perform a prediction of the deterioration tendency of the component included in the target vehicle by comparing the reference deterioration data acquired by the first acquirer and the target deterioration data acquired by the second acquirer with each other. The estimator is configured to estimate, with respect to the component included in the target vehicle, one or more deterioration factors and a contribution rate for each of the one or more deterioration factors.

An aspect of the disclosure provides a data processing method configured to predict a deterioration tendency over time of a component included in a target vehicle. The target vehicle is different from reference vehicles that belong to a predetermined vehicle group. The data processing method includes: collecting, for each of the components included in the respective reference vehicles, component deterioration data indicating a correspondence relationship between a degree of deterioration of the component and a temporal element of the component, in which the component included in the target vehicle and the components included in the respective reference vehicles are the same in kind as each other; acquiring, as reference deterioration data, a collection of the component deterioration data on the reference vehicles; acquiring the component deterioration data on the target vehicle as target deterioration data; predicting the deterioration tendency of the component included in the target vehicle by comparing the reference deterioration data acquired and the target deterioration data with each other; and estimating, with respect to the component included in the target vehicle, one or more deterioration factors and a contribution rate for each of the one or more deterioration factors.

An aspect of the disclosure provides a data processing system including reference vehicles, a target vehicle, and a data processing apparatus. The reference vehicles belong to a predetermined vehicle group. The target vehicle is different from the reference vehicles. The data processing apparatus is configured to predict a deterioration tendency over time of a component included in the target vehicle. The data processing apparatus includes circuitry configured to: collect, for each of the components included in the respective reference vehicles, component deterioration data indicating a correspondence relationship between a degree of deterioration of the component and a temporal element of the component, in which the component included in the target vehicle and the components included in the respective reference vehicles are the same in kind as each other; acquire, as reference deterioration data, a collection of the component deterioration data on the reference vehicles; acquire the component deterioration data on the target vehicle as target deterioration data; predict the deterioration tendency of the component included in the target vehicle by comparing the reference deterioration data and the target deterioration data with each other; and estimate, with respect to the component included in the target vehicle, one or more deterioration factors and a contribution rate for each of the one or more deterioration factors.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic diagram illustrating a schematic configuration example of a data processing system according to one example embodiment of the disclosure.

FIG. 2 is a block diagram illustrating a detailed configuration example of the data processing system illustrated in FIG. 1.

FIG. 3 is a characteristic diagram illustrating an example of various pieces of component deterioration data on reference vehicles and a target vehicle.

FIG. 4 is a flowchart illustrating an example of a process of predicting a deterioration tendency of a component according to one example embodiment.

FIG. 5 is a schematic diagram illustrating examples of a notification content for a user of the target vehicle.

FIG. 6 is a block diagram illustrating a detailed configuration example of a data processing system according to a modification example of the disclosure.

FIG. 7A is a flowchart illustrating an example of a process of predicting a deterioration tendency of a component according to the modification example.

FIG. 7B is a flowchart illustrating an example of the process of predicting the deterioration tendency of the component following the process of FIG. 7A.

### DETAILED DESCRIPTION

Maintenance data on a component included in a vehicle can include a prediction result of a deterioration tendency of the component. What is desired is to improve a prediction accuracy upon predicting the deterioration tendency of the component included in such a target vehicle to be predicted.

It is desirable to provide a data processing system, a data processing apparatus, and a data processing method that make it possible to improve a prediction accuracy of a deterioration tendency of a component included in a target vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### Example Embodiment

### Configuration Example

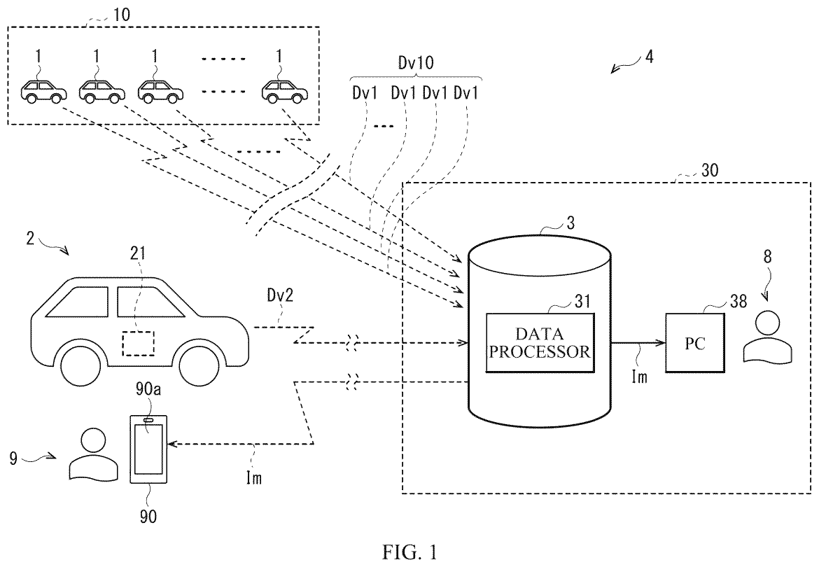

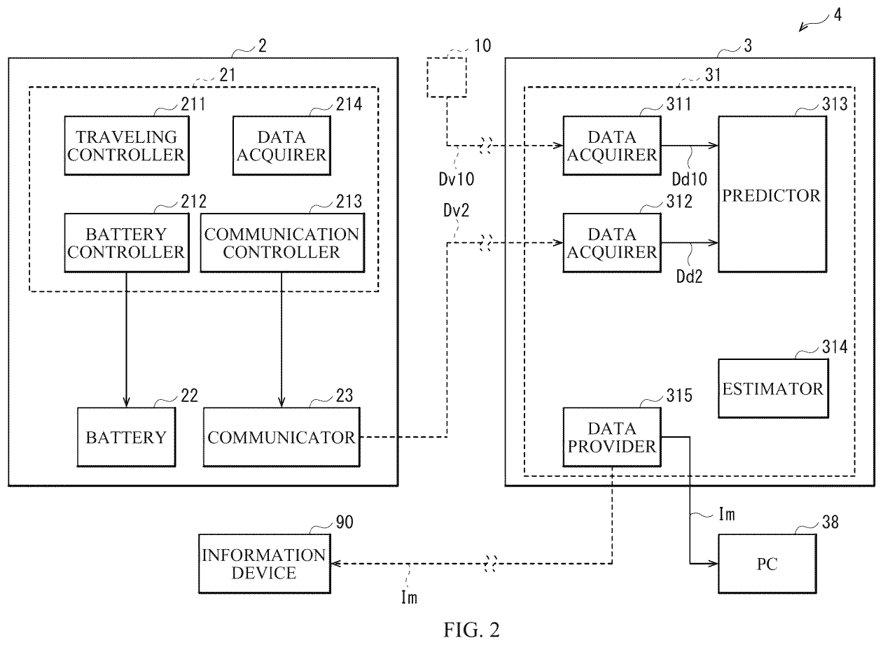

FIG. 1 schematically illustrates a schematic configuration example of a data processing system 4 according to an example embodiment of the disclosure. FIG. 2 is a block diagram illustrating a detailed configuration example of the data processing system 4 illustrated in FIG. 1.

The data processing system 4 predicts a deterioration tendency of a vehicle component. The data processing system 4 predicts the deterioration tendency over time of a component included in a target vehicle 2. Referring to FIGS. 1 and 2, the data processing system 4 includes: reference vehicles 1 that belong to a predetermined vehicle group 10; the target vehicle 2 as a vehicle to which the deterioration tendency is to be predicted; and a data processing apparatus 3 that predicts the deterioration tendency of the component included in the target vehicle 2.

Note that a data processing method, or a method of predicting the deterioration tendency of the vehicle component, according to an example embodiment of the disclosure is embodied by an operation of the data processing system 4, and will be described below together with the data processing system 4. The component or the vehicle component to be subjected to the prediction of the deterioration tendency may be any of various consumable parts and replacement parts. Non-limiting examples of the component to be subjected to the prediction of the deterioration tendency may include a battery, a brake pad, engine oil, a wheel, and a wiper. In the example embodiment and a later-described modification example, the component to be subjected to the prediction of the deterioration tendency may be a battery, although it is not limited thereto.

### Target Vehicle 2

The target vehicle 2 may be a vehicle owned by a user 9 or an owner 9. The target vehicle 2 is different from the reference vehicles 1. As illustrated in FIGS. 1 and 2, the target vehicle 2 may include a vehicle controller 21, a battery 22, and a communicator 23. The user 9 of the target vehicle 2 may have an information device 90 provided with a display 90a.

The vehicle controller 21 may be a member or a control unit that controls various operations of the target vehicle 2 and performs various kinds of arithmetic processing. The vehicle controller 21 may include one or more processors that execute programs, and one or more memories communicably coupled to the processors. The processor may be a central processing unit (CPU). The memory may include, for example, a random-access memory (RAM) that temporarily stores process data and a read-only memory (ROM) that stores programs.

In an example illustrated in FIG. 2, the vehicle controller 21 may include a traveling controller 211, a battery controller 212, a communication controller 213, and a data acquirer 214.

The traveling controller 211 may be a unit that controls a traveling operation of the target vehicle 2, and perform an overall control related to traveling of the target vehicle 2. For example, the traveling controller 211 may perform a control of systems including, for example, a driving system, a braking system, and the steering system of the target vehicle 2.

The battery controller 212 may be a unit that controls operations including, for example, a charging operation and a discharging operation of the later-described battery 22. The communication controller 213 may be a unit that controls a communication operation of the later-described communicator 23.

The data acquirer 214 may be a unit that acquires various types of data on the target vehicle 2, including vehicle data Dv2. Non-limiting examples of the vehicle data Dv2 may include: the vehicle identification number of the target vehicle 2; traveling data such as a traveling distance or imaging data around the target vehicle 2; and data indicating a use state of the component such as an internal resistance value of the battery 22.

The battery 22 may be a component that serves as a power source of the target vehicle 2. The battery 22 may include various secondary batteries such as a lithium-ion battery. In one embodiment, the battery 22 may serve as a “component”.

The communicator 23 may be a device that performs a communication with the data processing apparatus 3. As illustrated in FIGS. 1 and 2, the communicator 23 may transmit the vehicle data Dv2 acquired by the data acquirer 214 to the data processing apparatus 3.

### Data Processing Apparatus 3

The data processing apparatus 3 may be a server. The data processing apparatus 3 may include a data processor 31 as illustrated in FIGS. 1 and 2. The data processing apparatus 3 may be disposed in a vehicle manufacturer 30 as illustrated in FIG. 1.

The data processor 31 may be a unit such as an arithmetic processing unit that performs various arithmetic processing. For example, the data processor 31 may include one or more processors that execute programs, and one or more memories communicably coupled to the processors. The processor may be the CPU. The memory may include, for example, the RAM that temporarily stores process data and the ROM that stores programs.

In an example illustrated in FIG. 2, the data processor 31 may include data acquirers 311 and 312, a predictor 313, an estimator 314, and a data provider 315. In one embodiment, the data acquirer 311 may serve as a “first acquirer”. In one embodiment, the data acquirer 312 may serve as a “second acquirer”.

As illustrated in FIGS. 1 and 2, the data acquirer 311 is a unit that acquires component deterioration data, based on vehicle data Dv10 collected from a vehicle group 10. The component deterioration data may be reference deterioration data Dd10. The vehicle group 10 may be the reference vehicles 1. The vehicle data Dv10 may be a collection of the pieces of vehicle data Dv1. For example, the data acquirer 311 may collect the component deterioration data Dd1 for the component included in each of the reference vehicles 1, based on the vehicle data Dv1 for each of the reference vehicles 1. In some embodiments, the component included in each of the reference vehicles 1 may be a battery. The data acquirer 311 may acquire the collection of component deterioration data Dd1 on the reference vehicles 1 as reference deterioration data Dd10. As with the vehicle data Dv2 described above, non-limiting examples of the vehicle data Dv1 may include: the vehicle identification number; the traveling data such as the traveling distance or the imaging data around each reference vehicle 1; and the data indicating the use status of the component such as the internal resistance value of the battery included in each reference vehicle 1.

As illustrated in FIGS. 1 and 2, the data acquirer 312 is a unit that acquires the component deterioration data on the target vehicle 2 as the target deterioration data Dd2, based on the vehicle data Dv2 transmitted from the target vehicle 2 or the communicator 23.

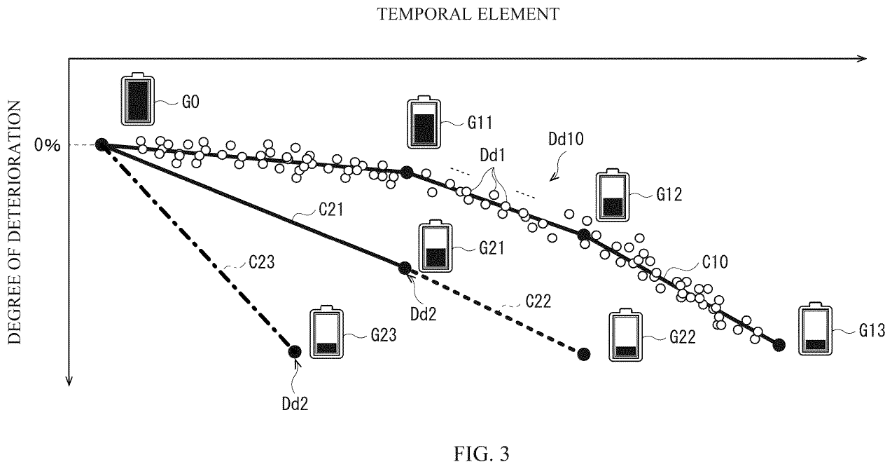

A description is given here in detail with reference to FIG. 3 on the various types of component deterioration data, including the component deterioration data Dd1, the reference deterioration data Dd10, and the target deterioration data Dd2. FIG. 3 is a characteristic diagram illustrating an example of various pieces of component deterioration data of the reference vehicles 1 and the target vehicle 2. In FIG. 3, reference numerals G0, G11 to G13, G21, G22, and G23 schematically illustrate states of remaining battery levels in respective states.

FIG. 3 illustrates the collection of pieces of component deterioration data Dd1 on the respective reference vehicles 1 and the component deterioration data on the target vehicle 2. In other words, FIG. 3 illustrates the reference deterioration data Dd10 on the vehicle group 10 to which the reference vehicles 1 belong and the target deterioration data Dd2. Each of the pieces of component deterioration data Dd1 and the target deterioration data Dd2 each indicate a correspondence relationship between a degree of deterioration and a temporal element. The degree of deterioration of the component may be an internal resistance value of the battery. The temporal element may be a use period.

A deterioration tendency line C10 may indicate the deterioration tendency over time of the component in the vehicle group 10, in the reference deterioration data Dd10 as the collection of the pieces of component deterioration data Dd1. Deterioration prediction lines C21 to C23 indicate the deterioration tendency over time of the component in the target vehicle 2, based on the target deterioration data Dd2. For example, the deterioration prediction lines C21 and C22 may indicate a first example of the deterioration tendency that is based on the target deterioration data Dd2. The first example may be an example of the deterioration tendency of the component in the target vehicle 2. The deterioration prediction line C23 may indicate a second example of the deterioration tendency that is based on the target deterioration data Dd2. The second example may be another example of the deterioration tendency of the component in the target vehicle 2. The deterioration tendencies of the first example and the second example each may be stronger or larger in deterioration tendency than the deterioration tendency of the vehicle group 10. In addition, the deterioration tendency of the second example, i.e., the deterioration tendency based on the deterioration prediction line C23, may be further stronger than the deterioration tendency of the first example, i.e., the deterioration tendency based on the deterioration prediction lines C21 and C22.

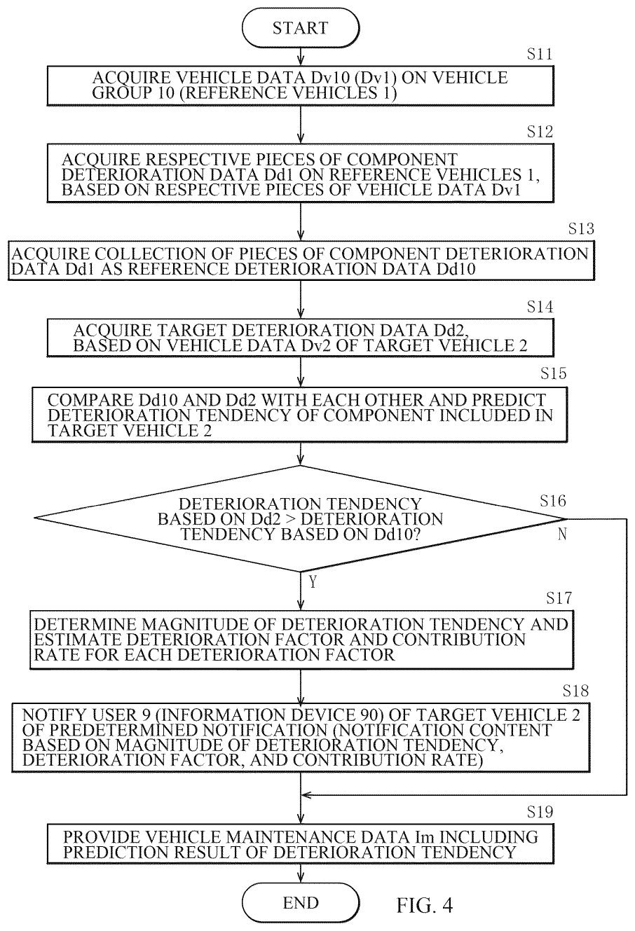

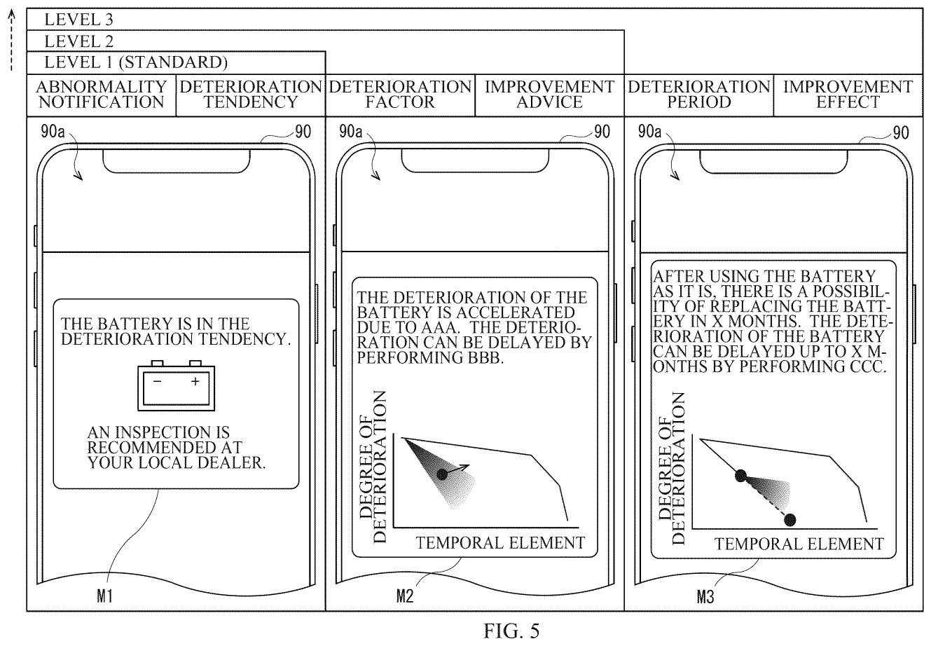

The predictor 313 is a unit that predicts the deterioration tendency of the component included in the target vehicle 2 by comparing the reference deterioration data Dd10 acquired by the data acquirer 311 and the target deterioration data Dd2 acquired by the data acquirer 312 with each other. Note that details of a prediction process to be performed by the predictor 313 will be described later with reference to FIGS. 4 and 5.

The estimator 314 is a unit that estimates one or more deterioration factors and a contribution rate for each of the deterioration factors with respect to the component included in the target vehicle 2, based on the target deterioration data Dd2.

The data provider 315 may be a unit that provides vehicle maintenance data Im of the target vehicle 2 to the outside. The vehicle maintenance data Im of the target vehicle 2 may include a result of the prediction performed by the predictor 313 and a result of the estimation performed by the estimator 314. The result of the prediction performed by the predictor 313 may be a prediction result of the deterioration tendency of the component. The result of the estimation performed by the estimator 314 may be the deterioration factor and the contribution rate described above. In an example illustrated in FIG. 2, the data provider 315 may provide the vehicle maintenance data Im including the prediction result and the estimation result to each of the user 9 of the target vehicle 2 and an employee 8 in the vehicle manufacturer 30. For example, the data provider 315 may provide the vehicle maintenance data Im to each of the information device 90 and a personal computer (PC) 38 used by the employee 8.

The data provider 315 may provide a predetermined notification upon providing the vehicle maintenance data Im, when the deterioration tendency of the component in the target vehicle 2 predicted by the predictor 313 is stronger than the deterioration tendency of the component of the vehicle group 10 indicated by the reference deterioration data Dd10. For example, when the deterioration tendency of the component in the target vehicle 2 predicted by the predictor 313 is stronger than the deterioration tendency of the component of the vehicle group 10 indicated by the reference deterioration data Dd10, the data provider 315 may perform a predetermined notification to each of the user 9, or the information device 90, of the target vehicle 2 and the employee 8, or the PC 38, in the vehicle manufacturer 30. Further, although details will be described later with reference to FIG. 5, the data provider 315 may change a content of the notification when the deterioration tendency of the component in the target vehicle 2 predicted by the predictor 313 is stronger than the deterioration tendency of the component of the vehicle group 10 indicated by the reference deterioration data Dd10, in accordance with a magnitude of the deterioration tendency of the component in the target vehicle 2 and the deterioration factor and the contribution rate estimated by the estimator 314.

In one embodiment, the data provider 315 may serve as a “data provider” and a “notifier”.

### Operation, Workings, and Example Effects

Next, an operation, workings, and example effects of the example embodiment will be described in detail.

### A. General Vehicle Maintenance

For example, upon a general vehicle maintenance, a maintenance reminder such as a periodic inspection is performed by setting a predetermined parameter for various components in the vehicle. Non-limiting examples of the predetermined parameter may include a use period of a component and a traveling distance. In other words, the deterioration tendency of the component is uniformly predicted, based on the predetermined parameter regardless of a situation of each vehicle.

In practice, however, the degree of component deterioration of the vehicle differs depending on the use state of the vehicle for each user. Accordingly, the maintenance time of the vehicle is to be set for each user. Hence, because a situation unique to the component, such as the degree of deterioration of the component, in the vehicle is not reflected in the general vehicle maintenance, there is a possibility in the general vehicle maintenance that a prediction accuracy of the deterioration tendency of the component becomes insufficient.

### B. Example of Prediction Process of Deterioration Tendency of Component

Accordingly, the data processing system 4 according to the example embodiment may predict the deterioration tendency over time of the component, such as the battery, included in the target vehicle 2 as follows.

FIG. 4 is a flowchart illustrating an example of a prediction process that is to be performed by the data processing apparatus 3 and predicts the deterioration tendency of the component according to the example embodiment. FIG. 5 schematically illustrates examples of the content of the notification to the user 9, or the information device 90, of the target vehicle 2.

In a series of processes illustrated in FIG. 4, the data acquirer 311 may acquire the vehicle data Dv10, i.e., the pieces of vehicle data Dv1 on the respective reference vehicles 1, on the vehicle group 10 from the reference vehicles 1 that belong to the vehicle group 10 (step S11). Thereafter, the data acquirer 311 may perform a predetermined extracting process that is based on the acquired vehicle data Dv on each of the reference vehicles 1 and thereby acquire the component deterioration data Dd1 on each of the reference vehicles 1 (step S12). Thereafter, the data acquirer 311 may acquire the collection of the pieces of component deterioration data Dd1 as the reference deterioration data Dd10 (step S13).

Thereafter, the data acquirer 312 may acquire the vehicle data Dv2 on the target vehicle 2 from the target vehicle 2, or the communicator 23, and perform a predetermined extracting process based on the acquired vehicle data Dv2 and thereby acquire the component deterioration data, i.e., the target deterioration data Dd2, on the target vehicle 2 (step S14).

Thereafter, the predictor 313 may predict the deterioration tendency of the component included in the target vehicle 2 by comparing the thus-obtained reference deterioration data Dd10 and the target deterioration data Dd2 with each other (step S15). For example, the predictor 313 may predict the deterioration tendency of the component included in the target vehicle 2, based on a predetermined analysis process that is based on the comparison between the reference deterioration data Dd10 and the target deterioration data Dd2.

Thereafter, the predictor 313 may determine whether the thus-predicted deterioration tendency of the component in the target vehicle 2, i.e., the deterioration tendency based on the target deterioration data Dd2, is stronger or larger than the deterioration tendency of the component in the vehicle group 10, i.e., the deterioration tendency based on the reference deterioration data Dd10 (step S16). If the predictor 313 determines that the deterioration tendency of the target deterioration data Dd2 is weaker or smaller than the deterioration tendency of the reference deterioration data Dd10 (step S16: N), the process may proceed to later-described step S19.

If the predictor 313 determines that the deterioration tendency of the target deterioration data Dd2 is stronger than the deterioration tendency of the reference deterioration data Dd10 (step S16: Y), the predictor 313 may determine a magnitude of the deterioration tendency of the component in the target vehicle 2, and the estimator 314 may estimate, based on the target deterioration data Dd2, one or more deterioration factors and the contribution rate for each of the deterioration factors with respect to the component included in the target vehicle 2 (step S17). Thereafter, the data provider 315 may notify the user 9 of the target vehicle 2, the information device 90, or any other person or a device of a predetermined notification (step S18). At this time, the data provider 315 may set the content of the notification in accordance with the magnitude of the deterioration tendency of the component in the target vehicle 2, the deterioration factor, and the contribution rate determined or estimated in step S17.

For example, as illustrated in FIG. 5, the notification may be performed with content classified into levels such as the content of “Level 1” to “Level 3” indicated by broken arrows in FIG. 5 in a stepwise manner, in accordance with the magnitude of the deterioration tendency, the deterioration factor, and the contribution rate.

In an example illustrated in FIG. 5, in the notification content of “level 1 (standard)”, a notification M1 corresponding to an abnormality notification on the deterioration tendency may be displayed on the information device 90 of the user 9, such as on the display 90a. In an example of the notification M1, a comment “The battery is in the deterioration tendency. An inspection is recommended at your local dealer” is displayed together with a schematic diagram of the battery.

In the notification content of “Level 2”, a notification M2 corresponding to an improvement advice that is based on the deterioration factor may be displayed on the information device 90 of the user 9, such as on the display 90a. In an example of the notification M2, a comment “The deterioration of the battery is accelerated due to AAA. The deterioration can be delayed by performing BBB” may be displayed together with a schematic diagram corresponding to the component deterioration data Dd2.

In the notification content of “Level 3”, a notification M3 corresponding to a deterioration period and an improvement effect may be displayed on the information device 90 of the user 9, such as to the display 90a. In an example of the notification M3, a comment “After using the battery as it is, there is a possibility of replacing the battery in X months. The deterioration of the battery can be delayed up to X months by performing CCC” may be displayed together with a schematic diagram corresponding to the component deterioration data Dd2.

Thereafter, the data provider 315 may provide the vehicle maintenance data Im of the target vehicle 2 including, for example, the prediction result obtained in step S15, to the user 9 of the target vehicle 2, such as the information device 90 (step S19). The prediction result may be related to the deterioration tendency of the component in the target vehicle 2. At this time, the estimation result, i.e., the estimation result of the deterioration factor and the contribution rate, obtained in step S17 may also be included in the vehicle maintenance data Im.

Thereafter, the series of processes illustrated in FIG. 4 may be completed.

### C. Workings and Example Effects

In the example embodiment, the deterioration tendency of the component included in the target vehicle 2 is predicted by comparing with each other the collection of the pieces of component deterioration data Dd1, i.e., the reference deterioration data Dd10, on the reference vehicles 1 that belong to the predetermined vehicle group 10 and the component deterioration data, i.e., the target deterioration data Dd2, on the target vehicle 2.

Accordingly, in the example embodiment, as compared with an example case where the deterioration tendency of the component is uniformly predicted based on a predetermined parameter, such as the use period of the component or the traveling distance of the vehicle, the prediction of the deterioration tendency of the component that reflects a situation unique to the component in the target vehicle 2, i.e., the degree of deterioration compared with the reference vehicles 1, is achieved. This configuration according to the example embodiment helps to improve the prediction accuracy of the deterioration tendency of the component included in the target vehicle 2.

In some embodiments, the vehicle maintenance data Im including, for example, the prediction result of the deterioration tendency of the component included in the target vehicle 2 may be provided to the user 9 of the target vehicle 2, such as to the information device 90. This configuration helps to perform the maintenance of the target vehicle 2 with the prediction result of the deterioration tendency, and improve the convenience. In addition, the vehicle maintenance data Im may also be provided to the employee 8 in the vehicle manufacturer 30, such as to the PC 38. This configuration helps to utilize, for example, the predicted deterioration tendency in the vehicle manufacturer 30.

In some embodiments, a predetermined notification may be given to the user 9 of the target vehicle 2, such as to the information device 90, when the predicted deterioration tendency of the component in the target vehicle 2 is stronger than the deterioration tendency of the component in the vehicle group 10 indicated by the reference deterioration data Dd10. This configuration helps to allow the user 9 of the target vehicle 2 to know in advance that the prediction result indicates that the deterioration tendency is strong, and thus to improve convenience.

In some embodiments, the content of the notification to the user 9 of the target vehicle 2 may be changed in accordance with the magnitude of the deterioration tendency of the component in the target vehicle 2, the estimated deterioration factor, and the contribution rate. This configuration helps to allow the user 9 to receive the notification content that reflects such detailed various kinds of data in advance with regard to the component deterioration of the target vehicle 2, and thus to further improve convenience. In some embodiments, changing the notification content or the levels of the notification content also helps to provide a useful notification advice for the user 9 of the target vehicle 2 or to utilize the notification advice in response to an inquiry from the user 9.

### Modification Examples

Next, modification examples of the example embodiment will be described. In the following description, the same components as those in the example embodiment are denoted by the same reference numerals, and description thereof will not be described in detail.

### Configuration Example

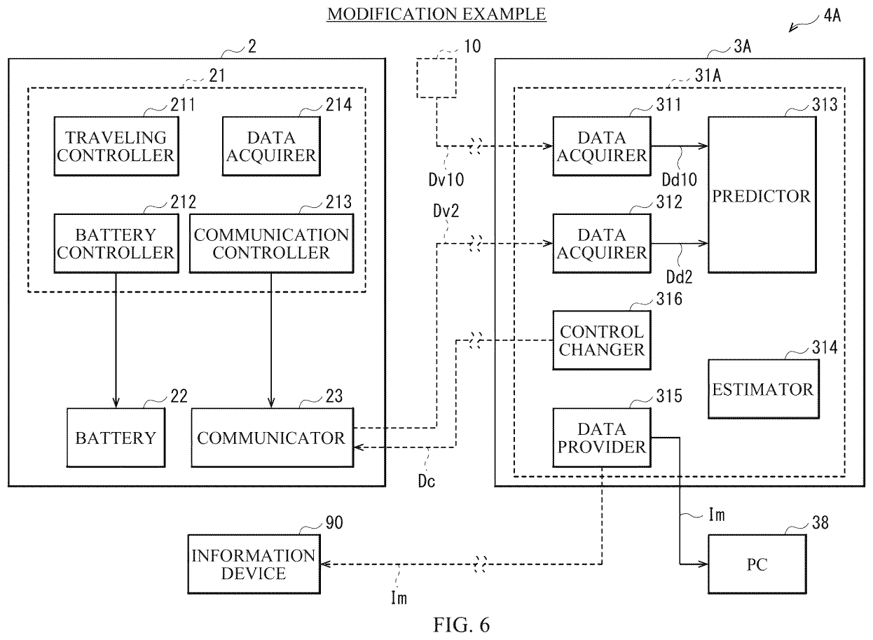

FIG. 6 is a block diagram illustrating a detailed configuration example of a data processing system 4A according to a modification example. The data processing system 4A according to the present modification example corresponds to the data processing system 4 according to the example embodiment illustrated in FIG. 2, in which a data processing apparatus 3A described below is provided instead of the data processing apparatus 3, and other configurations may be similar to those of the data processing system 4. Note that a data processing method, or a method of predicting the deterioration tendency of the vehicle component, according to the modification example of the disclosure is embodied by an operation of the data processing system 4A, and will be described below together with the data processing system 4A.

### Data Processing Apparatus 3A

The data processing apparatus 3A may correspond to the data processing apparatus 3 according to the example embodiment illustrated in FIG. 2, in which a data processor 31A described below is provided instead of the data processor 31, and other configurations may be similar to those of the data processing apparatus 3.

The data processor 31A may correspond to the data processor 31 according to the example embodiment illustrated in FIG. 2 in which a control changer 316 is further provided or added, and other configurations may be similar to those of the data processor 31.

As with the data processor 31, the data processor 31A may be a unit such as an arithmetic processing unit that performs various kinds of arithmetic processing. The data processor 31A may include one or more processors that execute programs, and one or more memories communicably coupled to the processors. The processor may be the CPU. The memory may include the RAM that temporarily stores process data and the ROM that stores programs.

The control changer 316 may change a content of a vehicle control to be executed inside the target vehicle 2, e.g., by the vehicle controller 21, when the deterioration tendency of the component in the target vehicle 2 predicted by the predictor 313 is stronger than the deterioration tendency of the component in the vehicle group 10 indicated by the reference deterioration data Dd10. For example, the control changer 316 may so change the content of the vehicle control to be executed in the target vehicle 2 as to be the vehicle control that weakens or delays the deterioration tendency of the component in the target vehicle 2. Referring to FIG. 6, such a change in the vehicle control content may be performed based on a control content change data Dc to be transmitted from the control changer 316 to the target vehicle 2, e.g., to the communicator 23.

### Operation, Workings, and Example Effects

### Example of Prediction Process According to Modification Example

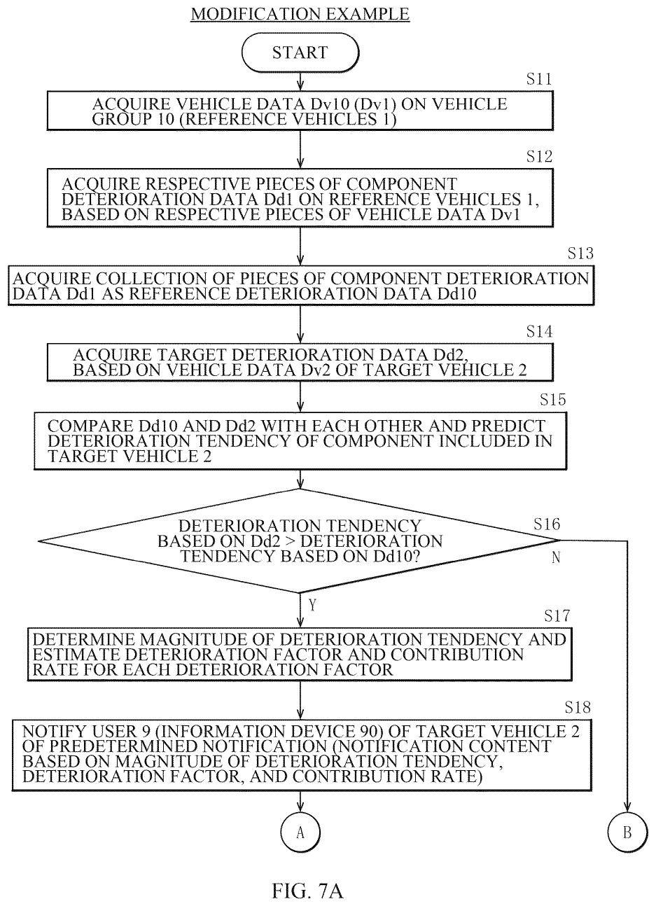

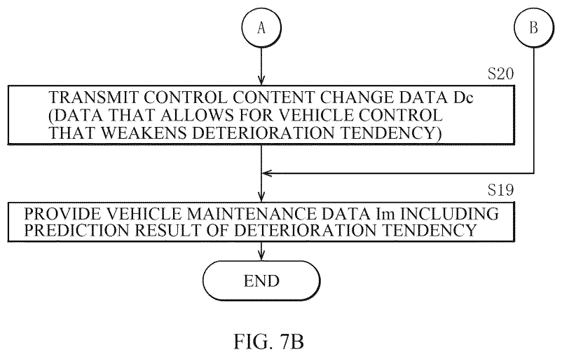

FIGS. 7A and 7B are each a flowchart illustrating an example of a prediction process of the deterioration tendency of the component to be performed by the data processing apparatus 3A according to a modification example. In an example of processes illustrated in FIGS. 7A and 7B, a process of step S20 to be described later may be added between steps S18 and S19 described above, i.e., after step S18, in the process example of FIG. 4 described in the example embodiment. Accordingly, the process of the added step S20 will be described below.

After the process of step S18 described above, the deterioration tendency of the component in the target deterioration data Dd2 may be stronger than the deterioration tendency of the component in the reference deterioration data Dd10 (step S16: Y). Accordingly, the control changer 316 may perform the process (step S20) in which the control changer 316 may transmit the control content change data Dc to the target vehicle 2, e.g., to the communicator 23. The control content change data Dc may be data that allows for the vehicle control that weakens the deterioration tendency of the component in the target vehicle 2.

After the process of step S20, the process of step S19 described above may be performed. Thus, a series of processes illustrated in FIGS. 7A and 7B ends.

### Workings and Example Effects

In the present modification example, the content of the vehicle control to be executed in the target vehicle 2 may be changed, when the predicted deterioration tendency of the component in the target vehicle 2 is stronger than the deterioration tendency of the component in the vehicle group 10 indicated by the reference deterioration data Dd10. This configuration makes it possible to change the content of the vehicle control in the target vehicle 2, based on the prediction result in which the deterioration tendency is strong. Accordingly, this configuration helps to improve convenience.

For example, in the present modification example, the content of the vehicle control in the target vehicle 2 may be so changed that the deterioration tendency of the component in the target vehicle 2 is weakened or the deterioration of the component is delayed. This configuration helps to weaken the deterioration tendency of the component in the target vehicle 2 by the change in the vehicle control content, and to further improve the convenience.

### Other Modification Examples

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, a configuration such as a type, an arrangement, or the number, of each member in a factor such as: the data processing apparatus 3 or 3A; the vehicle group 10 or the reference vehicles 1; or the target vehicle 2 is not limited to those described in the above-described example embodiments and their modification examples. A configuration of each of these members may involve any other factor such as any other types, arrangements, or the numbers. Further, a factor such as a value, a range, or a magnitude relationship of the various parameters described in the above-described embodiments and their modification examples are not limited to those described in the above-described embodiments and their modification examples, and may involve any other value, a range, a magnitude relationships, and so forth.

In the above-described embodiments and their modification examples, the processes to be performed by the data processing apparatus 3 or 3A, e.g., the process that predicts the deterioration tendency of the component, has been described by way of a specific example, but the processes are not limited to these examples. In some embodiments, the prediction process of the deterioration tendency of the component may be performed with another method.

In the above-described embodiments and their modification examples, the notification content for the user 9 of the target vehicle 2, or the information device 90, have been described by way of examples, but the disclosure is not limited to these examples. In some embodiments, the notification content may not be changed in accordance with a factor such as the magnitude of the deterioration tendency, the deterioration factor, or the contribution rate.

A series of processes described in the above-described embodiments and their modification examples may be performed by hardware (e.g., circuit), by software (e.g., program), or by a combination of hardware and software. When the processes are to be performed by the software, the software may include a program group that causes a computer to execute each operation. Each program may be incorporated in a computer in advance for use, or may be installed in the computer from a network or a non-transitory recording medium for use.

The techniques according to the example embodiments and their modification examples described above may be combined in any combination. The disclosure may encompass such combinations as example embodiments of the disclosure.

The example effects described herein are merely examples, and effects of the disclosure are not limited to the effects described herein. Accordingly, any other effect may be achieved by any embodiment of the disclosure.

The disclosure may include at least the following example configurations.

(1) A data processing system including: reference vehicles that belong to a predetermined vehicle group; a target vehicle that is different from the reference vehicles; and a data processing apparatus configured to predict a deterioration tendency over time of a component included in the target vehicle, in which the data processing apparatus includes a first acquirer configured to collect, for each of the components included in the respective reference vehicles, component deterioration data indicating a correspondence relationship between a degree of deterioration of the component and a temporal element of the component, and acquire, as reference deterioration data, a collection of the pieces of component deterioration data on the reference vehicles, a second acquirer configured to acquire the component deterioration data on the target vehicle as target deterioration data, a predictor configured to perform a prediction of the deterioration tendency of the component included in the target vehicle by comparing the reference deterioration data acquired by the first acquirer and the target deterioration data acquired by the second acquirer with each other, and an estimator configured to estimate, with respect to the component included in the target vehicle, one or more deterioration factors and a contribution rate for each of the one or more deterioration factors.

(2) The data processing system according to (1), in which the data processing apparatus further includes a notifier configured to give a predetermined notification to a user of the target vehicle, when the deterioration tendency of the target vehicle predicted by the predictor is stronger than the deterioration tendency of the vehicle group indicated by the reference deterioration data.

(3) The data processing system according to (2), in which the notifier is configured to change a content of the notification, in accordance with a magnitude of the deterioration tendency of the target vehicle.

(4) The data processing system according to (2) or (3), in which the notifier is configured to change a content of the notification, in accordance with the one or more deterioration factors and the contribution rate estimated by the estimator.

(5) The data processing system according to any one of (1) to (4), in which the data processing apparatus further includes a control changer configured to change a content of a vehicle control to be executed by the target vehicle, when the deterioration tendency of the target vehicle predicted by the predictor is stronger than the deterioration tendency of the vehicle group indicated by the reference deterioration data.

(6) The data processing system according to (5), in which the control changer is configured to change the content of the vehicle control to be executed by the target vehicle and cause the deterioration tendency of the target vehicle to be weakened accordingly.

(7) The data processing system according to any one of (1) to (6), in which the data processing apparatus further includes a data provider configured to provide, to a user of the target vehicle, vehicle maintenance data that includes a result of the prediction of the deterioration tendency of the component.

(8) A data processing apparatus configured to predict a deterioration tendency over time of a component included in a target vehicle, the target vehicle being different from reference vehicles that belong to a predetermined vehicle group, the data processing apparatus including: a first acquirer configured to collect, for each of the components included in the respective reference vehicles, component deterioration data indicating a correspondence relationship between a degree of deterioration of the component and a temporal element of the component, and acquire, as reference deterioration data, a collection of the pieces of component deterioration data on the reference vehicles; a second acquirer configured to acquire the component deterioration data on the target vehicle as target deterioration data; a predictor configured to perform a prediction of the deterioration tendency of the component included in the target vehicle by comparing the reference deterioration data acquired by the first acquirer and the target deterioration data acquired by the second acquirer with each other; and an estimator configured to estimate, with respect to the component included in the target vehicle, one or more deterioration factors and a contribution rate for each of the one or more deterioration factors.

(9) A data processing method configured to predict a deterioration tendency over time of a component included in a target vehicle, the target vehicle being different from reference vehicles that belong to a predetermined vehicle group, the data processing method including: collecting, for each of the components included in the respective reference vehicles, component deterioration data indicating a correspondence relationship between a degree of deterioration of the component and a temporal element of the component; acquiring, as reference deterioration data, a collection of the pieces of component deterioration data on the reference vehicles; acquiring the component deterioration data on the target vehicle as target deterioration data; predicting the deterioration tendency of the component included in the target vehicle by comparing the reference deterioration data and the target deterioration data with each other; and estimating, with respect to the component included in the target vehicle, one or more deterioration factors and a contribution rate for each of the one or more deterioration factors.

(10) A data processing system including: reference vehicles that belong to a predetermined vehicle group; a target vehicle that is different from the reference vehicles; and a data processing apparatus configured to predict a deterioration tendency over time of a component included in the target vehicle, in which the data processing apparatus includes circuitry configured to collect, for each of the components included in the respective reference vehicles, component deterioration data indicating a correspondence relationship between a degree of deterioration of the component and a temporal element of the component, acquire, as reference deterioration data, a collection of the pieces of component deterioration data on the reference vehicles, acquire the component deterioration data on the target vehicle as target deterioration data, predict the deterioration tendency of the component included in the target vehicle by comparing the reference deterioration data and the target deterioration data with each other, and estimate, with respect to the component included in the target vehicle, one or more deterioration factors and a contribution rate for each of the one or more deterioration factors.

(11) A data processing apparatus configured to predict a deterioration tendency over time of a component included in a target vehicle, the target vehicle being different from reference vehicles that belong to a predetermined vehicle group, the data processing apparatus including circuitry configured to collect, for each of the components included in the respective reference vehicles, component deterioration data indicating a correspondence relationship between a degree of deterioration of the component and a temporal element of the component, acquire, as reference deterioration data, a collection of the pieces of component deterioration data on the reference vehicles, acquire the component deterioration data on the target vehicle as target deterioration data, predict the deterioration tendency of the component included in the target vehicle by comparing the reference deterioration data and the target deterioration data with each other, and estimate, with respect to the component included in the target vehicle, one or more deterioration factors and a contribution rate for each of the one or more deterioration factors.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive. As used in this specification and the appended claims, the singular forms “a,” “an,” and “the” include, especially in the context of the claims, are to be construed to cover both the singular and the plural, unless otherwise indicated herein or clearly contradicted by context. Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step. The use of the terms first, second, etc. do not denote any order or importance, but rather the terms first, second, etc. are used to distinguish one element from another. The term “substantially”, “approximately”, “about”, and its variants having the similar meaning thereto are defined as being largely but not necessarily wholly what is specified as understood by one of ordinary skill in the art. The term “disposed on/provided on/formed on” and its variants having the similar meaning thereto as used herein refer to elements disposed directly in contact with each other or indirectly by having intervening structures therebetween.

The vehicle controller 21 illustrated in FIGS. 1, 2 and 6, the data processor 31 illustrated in FIGS. 1 and 2, and the data processor 31A illustrated in FIG. 6 are each implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the vehicle controller 21, the data processor 31, and the data processor 31A. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the vehicle controller 21 illustrated in FIGS. 1, 2 and 6, the data processor 31 illustrated in FIGS. 1 and 2, and the data processor 31A illustrated in FIG. 6.

What is claimed is:

1. A data processing system comprising:
reference vehicles that belong to a predetermined vehicle group;
a target vehicle that is different from the reference vehicles; and
a data processing apparatus configured to predict a deterioration tendency over time of a component comprised in the target vehicle, wherein
the data processing apparatus comprises
a first acquirer configured to collect, for each of the components comprised in the respective reference vehicles, component deterioration data indicating a correspondence relationship between a degree of deterioration of the component and a temporal element of the component, and acquire, as reference deterioration data, a collection of the component deterioration data on the reference vehicles, the component comprised in the target vehicle and the components comprised in the respective reference vehicles being same in kind as each other
a second acquirer configured to acquire the component deterioration data on the target vehicle as target deterioration data,
a predictor configured to perform a prediction of the deterioration tendency of the component comprised in the target vehicle by comparing the reference deterioration data acquired by the first acquirer and the target deterioration data acquired by the second acquirer with each other, and
an estimator configured to estimate, with respect to the component comprised in the target vehicle, one or more deterioration factors and a contribution rate for each of the one or more deterioration factors.

2. The data processing system according to claim 1, wherein the data processing apparatus further comprises a notifier configured to give a predetermined notification to a user of the target vehicle, when the deterioration tendency of the target vehicle predicted by the predictor is stronger than the deterioration tendency of the vehicle group indicated by the reference deterioration data.

3. The data processing system according to claim 2, wherein the notifier is configured to change a content of the notification, in accordance with a magnitude of the deterioration tendency of the target vehicle.

4. The data processing system according to claim 2, wherein the notifier is configured to change a content of the notification, in accordance with the one or more deterioration factors and the contribution rate estimated by the estimator.

5. The data processing system according to claim 1, wherein the data processing apparatus further comprises a control changer configured to change a content of a vehicle control to be executed by the target vehicle, when the deterioration tendency of the target vehicle predicted by the predictor is stronger than the deterioration tendency of the vehicle group indicated by the reference deterioration data.

6. The data processing system according to claim 2, wherein the data processing apparatus further comprises a control changer configured to change a content of a vehicle control to be executed by the target vehicle, when the deterioration tendency of the target vehicle predicted by the predictor is stronger than the deterioration tendency of the vehicle group indicated by the reference deterioration data.

7. The data processing system according to claim 3, wherein the data processing apparatus further comprises a control changer configured to change a content of a vehicle control to be executed by the target vehicle, when the deterioration tendency of the target vehicle predicted by the predictor is stronger than the deterioration tendency of the vehicle group indicated by the reference deterioration data.

8. The data processing system according to claim 4, wherein the data processing apparatus further comprises a control changer configured to change a content of a vehicle control to be executed by the target vehicle, when the deterioration tendency of the target vehicle predicted by the predictor is stronger than the deterioration tendency of the vehicle group indicated by the reference deterioration data.

9. The data processing system according to claim 5, wherein the control changer is configured to change the content of the vehicle control to be executed by the target vehicle and cause the deterioration tendency of the target vehicle to be weakened accordingly.

10. The data processing system according to claim 6, wherein the control changer is configured to change the content of the vehicle control to be executed by the target vehicle and cause the deterioration tendency of the target vehicle to be weakened accordingly.

11. The data processing system according to claim 7, wherein the control changer is configured to change the content of the vehicle control to be executed by the target vehicle and cause the deterioration tendency of the target vehicle to be weakened accordingly.

12. The data processing system according to claim 8, wherein the control changer is configured to change the content of the vehicle control to be executed by the target vehicle and cause the deterioration tendency of the target vehicle to be weakened accordingly.

13. The data processing system according to claim 1, wherein the data processing apparatus further comprises a data provider configured to provide, to a user of the target vehicle, vehicle maintenance data that comprises a result of the prediction of the deterioration tendency of the component.

14. The data processing system according to claim 2, wherein the data processing apparatus further comprises a data provider configured to provide, to a user of the target vehicle, vehicle maintenance data that comprises a result of the prediction of the deterioration tendency of the component.

15. The data processing system according to claim 3, wherein the data processing apparatus further comprises a data provider configured to provide, to a user of the target vehicle, vehicle maintenance data that comprises a result of the prediction of the deterioration tendency of the component.

16. The data processing system according to claim 4, wherein the data processing apparatus further comprises a data provider configured to provide, to a user of the target vehicle, vehicle maintenance data that comprises a result of the prediction of the deterioration tendency of the component.

17. A data processing apparatus configured to predict a deterioration tendency over time of a component comprised in a target vehicle, the target vehicle being different from reference vehicles that belong to a predetermined vehicle group, the data processing apparatus comprising:
a first acquirer configured to collect, for each of the components comprised in the respective reference vehicles, component deterioration data indicating a correspondence relationship between a degree of deterioration of the component and a temporal element of the component, and acquire, as reference deterioration data, a collection of component deterioration data on the reference vehicles, the component comprised in the target vehicle and the components comprised in the respective reference vehicles being same in kind as each other;
a second acquirer configured to acquire the component deterioration data on the target vehicle as target deterioration data;
a predictor configured to perform a prediction of the deterioration tendency of the component comprised in the target vehicle by comparing the reference deterioration data acquired by the first acquirer and the target deterioration data acquired by the second acquirer with each other; and
an estimator configured to estimate, with respect to the component comprised in the target vehicle, one or more deterioration factors and a contribution rate for each of the one or more deterioration factors.

18. A data processing method configured to predict a deterioration tendency over time of a component comprised in a target vehicle, the target vehicle being different from reference vehicles that belong to a predetermined vehicle group, the data processing method comprising:
collecting, for each of the components comprised in the respective reference vehicles, component deterioration data indicating a correspondence relationship between a degree of deterioration of the component and a temporal element of the component, the component comprised in the target vehicle and the components comprised in the respective reference vehicles being same in kind as each other;
acquiring, as reference deterioration data, a collection of component deterioration data on the reference vehicles;
acquiring the component deterioration data on the target vehicle as target deterioration data;
predicting the deterioration tendency of the component comprised in the target vehicle by comparing the reference deterioration data and the target deterioration data with each other; and
estimating, with respect to the component comprised in the target vehicle, one or more deterioration factors and a contribution rate for each of the one or more deterioration factors.

19. A data processing system comprising:
reference vehicles that belong to a predetermined vehicle group;
a target vehicle that is different from the reference vehicles; and
a data processing apparatus configured to predict a deterioration tendency over time of a component comprised in the target vehicle, wherein
the data processing apparatus comprises
circuitry configured to
collect, for each of the components comprised in the respective reference vehicles, component deterioration data indicating a correspondence relationship between a degree of deterioration of the component and a temporal element of the component, the component comprised in the target vehicle and the components comprised in the respective reference vehicles being same in kind as each other,
acquire, as reference deterioration data, a collection of the component deterioration data on the reference vehicles,
acquire the component deterioration data on the target vehicle as target deterioration data,
predict the deterioration tendency of the component comprised in the target vehicle by comparing the reference deterioration data and the target deterioration data with each other, and
estimate, with respect to the component comprised in the target vehicle, one or more deterioration factors and a contribution rate for each of the one or more deterioration factors.
